(19) United States
(12) Patent Application Publication
(10) Pub. No.: US 2011/0293168 A1
(43) Pub. Date: Dec. 1, 2011

(54) METHOD FOR MOUNTING TRANSPARENT COMPONENT

(76) Inventors: Yoshihiko Matsushima, Osaka (JP); Tadashi Kawakami, Osaka (JP); Tohru Imai, Osaka (JP); Montien Thuencharoen, Osaka (JP)

(21) Appl. No.: 12/787,173

(22) Filed: May 25, 2010

(51) Int. Cl. G06K 9/00

(52) U.S. Cl. 382/151

(57) ABSTRACT

A transparent component locally includes one or both of a plurality of thick parts that have a large thickness in the vertical direction, and a plurality of thin parts that have a small thickness in the vertical direction. A component recognition camera captures an image of the transparent component held by a mount head, from above or below the transparent component, while a single spotlight or a plurality of spotlights are being irradiated onto the transparent component.

### BACKGROUND OF THE INVENTION

(1) Field of the Invention

The present invention relates to technology for mounting a transparent component in a target position on a substrate by using a surface mounter.

(2) Description of the Related Art

Conventionally, a surface mounter has been widely used to mount a chip component in a target position on a substrate. A surface mounter operates in the following manners. First, the surface mounter causes a component recognition camera to capture an image of a chip component held by a mount head. Secondly, the surface mounter recognizes a held state of the chip component from the captured image, the held state denoting the state in which the chip component is being held (the position of a part of the chip component that is being held, and the angle by which the chip component has rotated about its axis along a vertical reference line). Thirdly, the surface mounter adjusts the mount head in position according to the held state. (For example, see JP Patent Application No. 2006-319271.) The held state of the chip component can be obtained by extracting a plurality of characteristic features of the chip component shown in the captured image, and then performing pattern matching on the characteristic features. It is therefore essential for the image captured by the component recognition camera to clearly show the characteristic features of the chip component.

There are two typical methods in which the component recognition camera performs image capturing: an outline characteristics extraction method, and an electrode extraction method. The outline characteristics extraction method is to (i) capture an image of an outline of the chip component while irradiating light from behind the chip component, and (ii) extract characteristic parts of the outline. The electrode extraction method is to (i) capture an image of an irradiated top surface of the chip component while irradiating light onto the top surface of the chip component, and (ii) extract areas in which electrodes are arranged, based on a difference between brightness of the electrodes and brightness of a main body of the chip component. Note, this difference arises from a difference between the reflection rate of the electrodes and the reflection rate of the main body of the chip component. Either method enables the captured image to show the characteristic features of the chip component.

### SUMMARY OF THE INVENTION

In recent years, productization of a certain type of light emitting module has been suggested—more specifically, a light emitting module manufactured by mounting a light emitting component (e.g., an LED component) and a lens component on a substrate in such a manner that the lens component covers the upper side of the light emitting component. Light distribution characteristics of this type of light emitting modules can be differentiated from one another, simply by constructing the light emitting modules with use of identical substrates, identical light emitting components, and different lens components. The advantage of the above method lies in being able to utilize identical light emitting components, yet providing various types of light emitting modules at low cost. To further increase the effect of cost reduction, it is desired in the future to manufacture light emitting modules more productively by using a surface mounter to mount lens components.

However, as an entirety of a lens component is transparent, it is difficult to capture an image of an outline of the lens component. Moreover, as a lens component does not include electrodes, the electrode extraction method cannot be employed, either. That is to say, the traditional image capturing methods do not allow the captured image to show characteristic features of such a transparent lens component. This gives rise to the problem that the lens component cannot be mounted precisely in a target position on a substrate. This problem is not limited to being associated with a lens component, but also applies to other transparent components such as a prism component.

The present invention aims to provide technology for mounting a transparent component precisely in a target position on a substrate by using a surface mounter.

To achieve the above aim, provided is a method for mounting a transparent component, comprising the steps of: causing a mount head to hold the transparent component; capturing an image of the transparent component with use of a component recognition camera, either from a top side or a bottom side of the transparent component, while the transparent component is being held by the mount head; recognizing a held state of the transparent component from the captured image; moving the mount head so as to offset a difference between the recognized held state and a reference state; and mounting the transparent component in a target position on a substrate by causing the mount head to release the transparent component, wherein the transparent component locally includes one or both of a plurality of thick parts that each have a large thickness along a direction in which the component recognition camera faces when capturing the image, and a plurality of thin parts that each have a small thickness along the direction, and the capturing step is performed while a single spotlight or a plurality of spotlights are being irradiated onto the transparent component.

By “locally” it means that, when viewing the transparent component from above (the top side of) or below (the bottom side of) the transparent component, the rate of an area taken up by each of the thick parts and the thin parts to an area taken up by an entirety of the transparent component is sufficiently small.

When a spotlight is irradiated onto the transparent component, the transmission, scattering, reflection, refraction, diffraction, etc. of the spotlight occurs while the spotlight is passing through the transparent component. Consequently, part of the spotlight travels toward the component recognition camera. By making the transparent component locally thick and/or thin, the amount of light transmitted therethrough toward the component recognition camera can be differentiated between the thick/thin parts and other part of the transparent component around the thick/thin parts. In the resultant captured image, the above difference is shown as a difference in local brightness levels, thus allowing to recognize the held state of the transparent component. As a result, the transparent component can be mounted precisely in the target position on the substrate.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 illustrates a method for mounting a transparent component in a target position on a substrate by using a surface mounter;

FIG. 2 shows the structure of an LED module;

FIG. 3A illustrates the principle of why a captured image shows different brightness levels in the following case: a lighting device and a component recognition camera are positioned facing each other with a lens component therebetween;

FIG. 3B illustrates the principle of why a captured image shows different brightness levels in the following case: a lighting device is positioned so that its spotlight travels obliquely downward to be incident on a reference surface at an angle of θ (the reference surface is perpendicular to the image capturing direction of the component recognition camera);

FIG. 4 shows a modification example of a lens component;

FIG. 5 shows another modification example of a lens component;

FIG. 6 shows yet another modification example of a lens component;

FIG. 7 shows yet another modification example of a lens component;

FIG. 8 shows yet another modification example of a lens component;

FIG. 9 shows one example of a captured image;

FIG. 10 shows another example of a captured image; and

FIG. 11 shows a modification example of an LED module.

### DESCRIPTION OF THE PREFERRED EMBODIMENT

The following is a detailed description of an embodiment for carrying out the present invention with reference to the accompanying drawings.

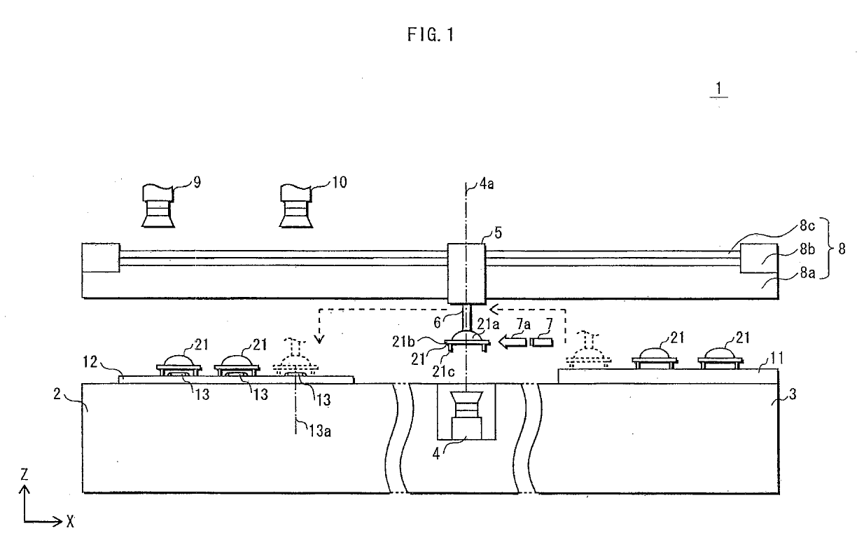

FIG. 1 illustrates a method for mounting a transparent component in a target position on a substrate by using a surface mounter. The present embodiment describes a situation where a lens component 21 (one example of a transparent component) is to be mounted on a substrate on which an LED component (one example of a light emitting component) has been mounted.

### <Surface Mounter>

A surface mounter 1 is composed of a base 2, a component supply unit 3, a component recognition camera 4, a mount head 5, a suction nozzle 6, a lighting device 7, a mount head drive mechanism 8, a substrate recognition camera 9, and an LED recognition camera 10.

A substrate 12, on which the LED component 13 has been mounted, is placed on the base 2. A component tray 11 containing the lens component 21 is placed on the component supply unit 3.

The mount head 5 picks up the lens component 21 from the component tray 11, and moves while holding the lens component 21. The mount head 5 then mounts the lens component 21 in a target position on the substrate 12 by releasing the lens component 21.

The operations of holding and releasing the lens component 21 are realized with the aid of a negative pressure generation device connected to the suction nozzle 6.

The operations of moving the lens component 21 in the X and Y directions are realized with the aid of the mount head drive mechanism 8. The mount head drive mechanism 8 includes a guide rail 8a, a servo motor 8b, and a ball screw 8c. Extending in the X direction, the guide rail 8a and the ball screw 8c transfer a rotation force of the servo motor 8b to the mount head 5 as a drive force acting in the X direction. For simplicity, FIG. 1 only illustrates the structure for moving the mount head 5 in the X direction. However, the description of the present embodiment is given under the assumption that the mount head drive mechanism 8 also has the structure for moving the mount head 5 in the Y direction.

The operations of moving the lens component 21 in the Z direction are realized with the aid of an elevator drive mechanism. The elevator drive mechanism is built into the mount head 5 for moving the suction nozzle 6 in the Z direction.

The operations of rotating the lens component 21 about the Z direction are realized with the aid of a rotation drive mechanism. The rotation drive mechanism is built into the mount head 5 for rotating the suction nozzle 6 about the Z direction. The amount by which the lens component 21 should be moved in the X and Y directions, and the angle by which the lens component 21 should be rotated about the Z direction, are determined so that moving and rotating the lens component 21 by the determined amount and angle would offset the difference between the held state and a reference state of the lens component 21. Hereinafter, such amount and angle are referred to as a move amount and a rotation angle, respectively. The reference state of the lens component 21 is information that is already known to the surface mounter 1. In contrast, the held state of the lens component 21 varies every time mounting of the lens component 21 is performed; therefore, the held state of the lens component 21 needs to be examined upon each mounting operation.

The component recognition camera 4 is positioned facing up in a vertical direction (the Z direction). When the mount head 5 has reached an image capturing position (the position in which the component recognition camera 4 is supposed to perform image capturing), the component recognition camera 4 captures an image of the lens component 21 from below the lens component 21. The captured image of the lens component 21 locally shows a plurality of spots that have different brightness levels. The reason for this phenomenon will be described later. The held state of a transparent component can be recognized by extracting these spots as characteristic features.

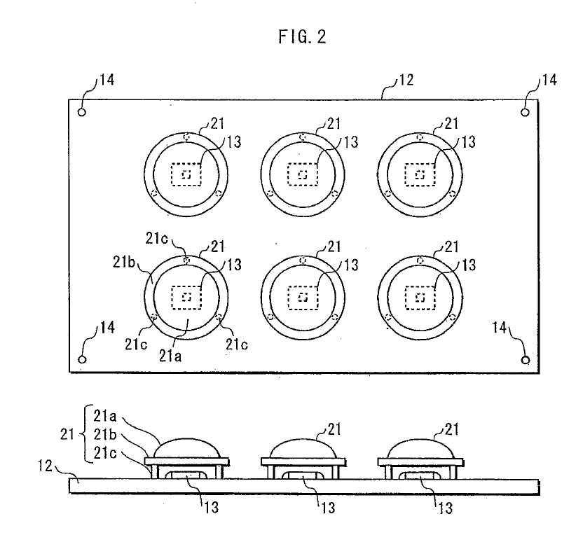

The substrate recognition camera 9 is positioned facing down in the vertical direction (the Z direction). An image captured by the substrate recognition camera 9 is used to detect reference marks 14 (see FIG. 2) formed on the substrate 12.

The LED recognition camera 10 is positioned facing down in the vertical direction (the Z direction). An image captured by the LED recognition camera 10 is used to detect the position of the LED component 13 mounted on the substrate 12.

When the mount head 5 has reached the image capturing position, the lighting device 7 irradiates a spotlight 7a onto the lens component 21.

### <Lens Component>

The lens component 21 is made of highly transparent resin or glass, and is formed as a unitary component by injection molding and the like. A main body of the lens component 21 is composed of a lens portion 21a and an annulus portion 21b. The lens portion 21a exerts the optical functions (light collection or light diffusion) inherent in a lens. The annulus portion 21b is continuous with an entire outer circumferential edge of the lens portion 21a. Leg portions 21c of the lens component 21 are provided to keep a clearance between the main body of the lens component 21 and the top surface of the substrate 12. The leg portions 21c are formed on a plurality of areas (three areas in the present embodiment) in the bottom surface of the annulus portion 21b, so as to protrude downward in the vertical direction (the Z direction) from these areas. The advantage of forming three or more leg portions 21c is that, even if one of the leg portions 21c is unglued for some reason, the remaining leg portions 21c can stably fix the main body of the lens component 21 in place.

The following shows exemplary measurements for the lens component 21. The lens portion 21a has a diameter of 15 [mm] and a maximum height of 4 [mm]. The annulus portion 21b has an inner diameter of 15 [mm], an outer diameter of 19 [mm], and a thickness of 1.6 [mm]. Each of the leg portions 21c has a diameter of 0.8 [mm] and a height of 2.5 [mm].

The leg portions 21c protrude downward from the bottom surface of the annulus portion 21b. Hence, the lens component 21 has a large thickness in the vertical direction in the leg portions 21.c. Also, the rate of an area on the substrate 12 taken up by each leg portion 21c to an area on the substrate 12 taken up by the main body of the lens component 21 is sufficiently small. That is to say, the lens component 21 locally includes a plurality of thick parts that each have a large thickness in the image capturing direction of the component recognition camera (the direction in which the component recognition camera faces when performing image capturing).

### <Principles>

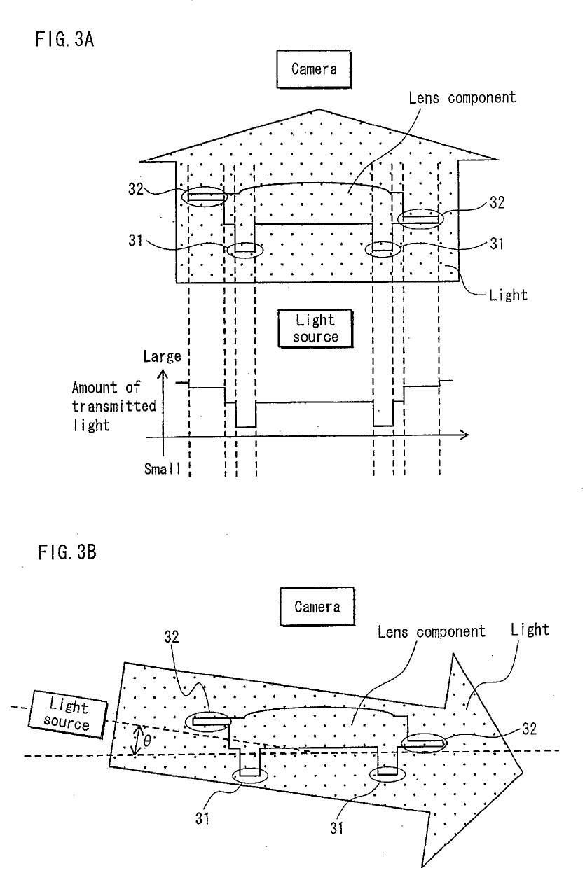

FIGS. 3A and 3B each illustrate the principle of why a captured image shows different brightness levels.

Each of the lens components shown in FIGS. 3A and 3B locally includes a plurality of thick and thin parts having a large and small thickness in the image capturing direction of the component recognition camera.

In FIG. 3A, the lighting device and the component recognition camera are positioned facing each other with the lens component therebetween. Here, the amount of light transmitted through the lens component is larger in each of the thin parts (reference number 32) than in a part around the thin parts. Conversely, the amount of light transmitted through the lens component is smaller in each of the thick parts (reference number 31) than in a part around the thick parts. As a result, the image captured by the component recognition camera locally shows bright spots and dark spots, which can be extracted as the characteristic features. Note that when the bottom end surfaces of the thick parts are colored or roughened, the amount of light transmitted through each thick part is further reduced, thus emphasizing the bright spots and the dark spots in the captured image.

In FIG. 3B, the lighting device is positioned so that is spotlight travels obliquely downward to be incident on a reference surface at an angle of θ (note, the reference surface is perpendicular to the image capturing direction of the component recognition camera). When the angle θ is adjusted to fall within a proper range, lights incident on the thick parts (reference number 31) and the thin parts (reference number 32) of the lens component repeatedly reflect off the inner surfaces of the lens component, and eventually diminish. As a result, these incident lights do not come out of the lens component. On the other hand, lights incident on other parts of the lens component around the thick parts and the thin parts are mostly transmitted through the lens component, but are partially irradiated onto the component recognition camera due to scattering and reflection. As a result, the image captured by the component recognition camera locally shows bright spots and dark spots.

Note, the experiments conducted for the present invention have revealed the following fact. The bright spots and the dark spots are more clearly shown in the captured image when a single-color LED is employed as a light source in the lighting device 7 than when a white LED is. This is presumably attributed to occurrence of the following phenomena. When white light is used, the angle of refraction of incident light varies depending on its wavelength; accordingly, the way the incident light travels inside the lens component varies depending on its wavelength. Therefore, even if light having a certain wavelength causes generation of bright spots and dark spots, light having another wavelength offsets such bright spots and dark spots. When single-color light is used, the aforementioned phenomena would not occur. The experiments have also revealed that bright spots and dark spots are more clearly shown when using, out of many single-color lights, blue light having a short wavelength. Note that when a single-color LED is employed and the bottom end surfaces of the thick parts and/or the thin parts are colored, the lens component should be made of a material that absorbs any light whose wavelength falls within the range of wavelengths of the single-color LED.

The following fact has also been found. Bright spots and dark spots are more clearly shown in the captured image if the width of the spotlight irradiated on the lens component is reduced by providing, for example, a light shielding member with an opening between the light source in the lighting device 7 and the lens component. The central part of the spotlight near its central axis is incident on the lens component at a different angle of incidence than other parts of the spotlight around the central part. Accordingly, inside the lens component, the central part of the spotlight travels differently than the other parts of the spotlight. Consequently, the following phenomenon may occur: even if light incident at a certain angle of incidence has caused generation of bright spots and dark spots, light incident at another angle of incidence offsets such bright spots and dark spots. Such a phenomenon is unlikely to occur when the width of the spotlight is reduced.

Also, when there is only one lighting device 7, the thick parts and/or the thin parts may produce shadows that become obstacles to component recognition. Such obstacles may be alleviated by providing a plurality of lighting devices 7 around the Z-axis of the lens component, and irradiating a plurality of spotlights onto the lens component.

### <Mount Procedures>

The following describes the procedures for mounting a lens component. First, the substrate 12, on which the LED component 13 has been mounted, is placed on the base 2. The LED component 13 is mounted on the substrate 12 by performing the following steps: (i) printing solder on the substrate 12; (ii) arranging the LED component 13 in a predetermined position on the substrate 12; and (iii) heat-fusing the solder on the substrate 12. The following operations are performed in arranging the LED component 13 on the substrate 12. The component recognition camera 4 captures an image of the LED component 13, and the held state of the LED component 13 is recognized from the captured image. Also, the substrate recognition camera 9 captures an image of the substrate 12, and the reference marks 14 (see FIG. 2) are detected from the captured image. Thereafter, the move amount and the rotation angle by which the LED component 13 should be moved and rotated are determined in accordance with the held state of the LED component 13 and the reference marks 14. Then, the mount head 5 is moved and rotated by the determined move amount and rotation angle. The above-described steps allow mounting the LED component 13 precisely in a predetermined position on the substrate 12.

Next, adhesives are applied to the substrate 12 in the positions where the leg portions 21c are to be placed. The position of the main body of the lens component 21 can be fine-tuned in the Z direction by adjusting the amount of the adhesives.

Next, the mount head 5 is moved so it is positioned above the component tray 11 on the component supply unit 3. After the suction nozzle 6 is lowered to the point where it comes in contact with the top surface of the lens component 21, the suction nozzle 6 holds the lens component 21. Then, the suction nozzle 6 is raised, and the mount head 5 is moved so that an optical axis 4a of the component recognition camera 4 and a central axis of the suction nozzle 6 are in line with each other. Thereafter, the component recognition camera 4 captures an image of the lens component 21 from below the lens component 21, and the held state of the lens component 21 is recognized from the captured image. Furthermore, the LED recognition camera 10 captures an image of the LED component 13 mounted on the substrate 12 from above the LED component 13, and the position of the mounted LED component 13 is identified from the captured image.

Next, in accordance with the held state of the lens component 21 and the position of the mounted LED component 13, the move amount by which the mount head 5 should be moved in the X and Y directions is determined, so that moving the mount head 5 by the determined move amount would put an optical axis of the lens component 21 and an optical axis 13a of the LED component 13 in line with each other. Similarly, the rotation angle by which the lens component 21 should be rotated is also determined, so that rotating the lens component 21 by the determined rotation angle would make each leg portion 21c coincide with the position of the corresponding adhesive applied to the substrate 12. Thereafter, the mount head 5 is moved by the determined move amount, and the suction nozzle 6 is rotated by the determined rotation amount. Then, after the suction nozzle 6 is lowered to the point where the leg portions 21c come in contact with the substrate 12, the suction nozzle 6 releases the lens component 21.

Finally, the adhesives are hardened. Note that once the lens component has been mounted on the substrate, the substrate may be conveyed to a specific place where the adhesives should be hardened. This conveyance operation may be conducted by using a method that would not move or apply impact to the substrate in the Z direction (e.g., a horizontal conveyor belt). By doing so, it is possible to prevent the lens component from getting displaced from a predetermined position before the adhesives are hardened.

### SUMMARY

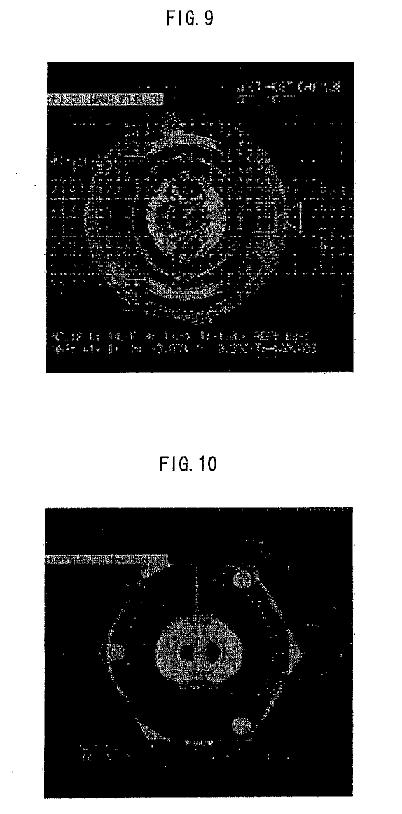

The present embodiment allows recognizing the held state of the lens component 21 (a transparent component). This makes it possible to mount the lens component 21 precisely in a target position on the substrate 12. FIGS. 9 and 10 show examples of a captured image.

The captured image shown in FIG. 9 is acquired by capturing an image of a lens component with the positional relationship shown in FIG. 3A maintained. Leg portions are included in three parts of the lens component, respectively. The end surfaces of these leg portions are colored. An annulus portion of this lens component has a thickness of approximately 1.6 [mm]. On the other hand, the leg portions of this lens component each have a height of approximately 0.2 [mm]. As is apparent from the captured image, there is a brightness/darkness difference between three thick parts (leg portions) and parts around the three thick parts.

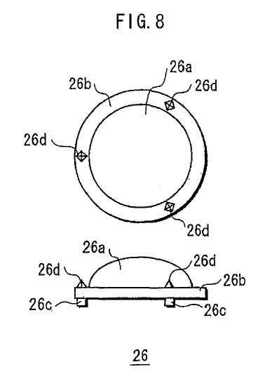

The captured image shown in FIG. 10 is acquired by capturing an image of a lens component with the positional relationship shown in FIG. 3B maintained (the angle θ is approximately 30 degrees). The lens component shown in FIG. 10 is the same as the one shown in FIG. 7. As is apparent from the captured image, there are brightness/darkness differences between three thick parts (leg portions), six thin parts (protruded portions), and parts around these thick/thin parts.

In the present embodiment, the lens component 21 is formed as a unitary component by injection molding and the like. Hence, there is little manufacturing variation that would bring about various positional relationships between the optical axis of lens portion 21a and leg portions 21c. That is to say, as long as the held state of the lens component 21 is recognized, the lens component 21 can be mounted precisely in the target position on the substrate. In a case where metallic films are formed on a plurality of areas in the bottom surface of a lens component, the held state of the lens component can also be recognized by using the electrode extraction method. In this case, however, manufacturing variations occur in lens components at the time of forming the metallic-films on the bottom surfaces of the lens components. This leads to the problem that the accuracy of the positions of the mounted lens components becomes lower than that pertaining to the present embodiment. Therefore, it is preferable to form a lens component as a unitary component as in the present embodiment.

Furthermore, in the present embodiment, the LED recognition camera captures an image of the LED component 13 mounted on the substrate 12 from above the substrate 12. After the position of the mounted LED component is recognized from the captured image, the recognized position is used as a reference for adjusting the lens component 21 in position. Even when the mounted LED component 13 is displaced from a reference position on the substrate 12, the above technique allows mounting the lens component 21 while maintaining a predetermined positional relationship between the LED component 13 and the lens component 21 (i.e., while maintaining the optical axis of the LED component 13 in line with the optical axis of the lens component 21).

### Modification Examples

The above has described the method for mounting the transparent component based on the embodiment. However, the present invention is not limited to the embodiment, and may be implemented according to, for example, the following modification examples.

(1) In the embodiment, only the leg portions 21c represent the thick parts that each have a large thickness in the vertical direction. However, the present invention is not limited to this structure. The transparent component may include other portions that also represent the thick parts, in addition to the leg portions.

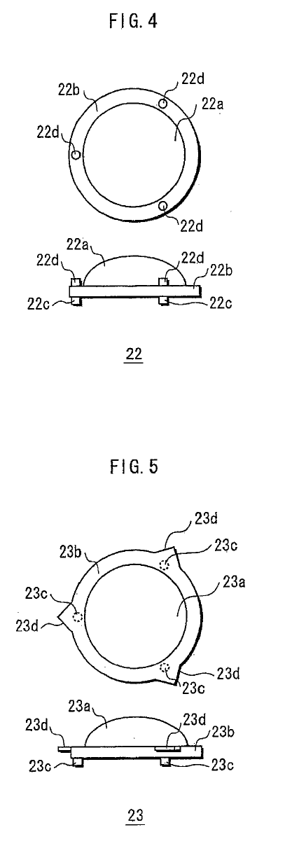

FIG. 4 shows a lens component 22 including protruded portions 22d, which protrude upward from a plurality of areas in the top surface of an annulus portion 22b. As the protruded portions 22d represent the thick parts that each have a large thickness in the vertical direction, a captured image of the lens component 22 shows bright and dark spots. In the example shown in FIG. 4, the protruded portions 22d are positioned so they respectively overlap leg portions 22c when viewed in the vertical direction. However, the protruded portions 22d are not limited to being positioned in such a manner. Each protruded portion 22d may be misaligned with the corresponding leg portion 22c when viewed in the vertical direction, in such a way that each protruded portion 22d and the corresponding leg portion 22c maintain a certain positional relationship relative to each other.

FIG. 5 shows a lens component 23 including protruded portions 23d, which (i) protrude radially outward from a plurality of areas in a side surface of an annulus portion 23b, and (ii) have a smaller thickness than the annulus portion 23b. As the protruded portions 23d represent the thin parts that each have a small thickness in the vertical direction, a captured image of the lens component 23 shows bright and dark spots.

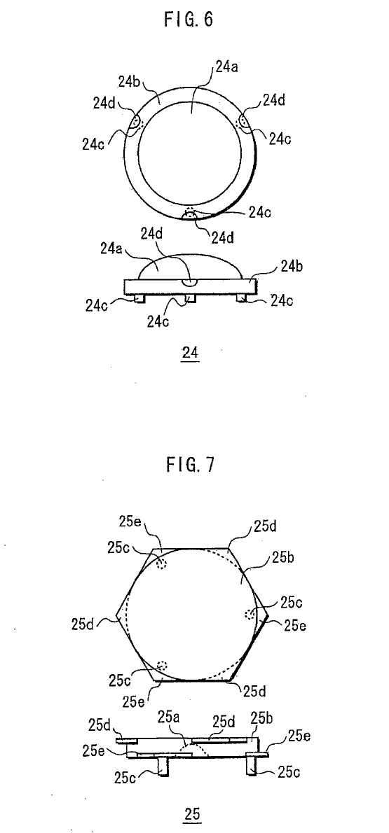

FIG. 6 shows a lens component 24 including depressions 24d, which are formed in a plurality of areas in the top surface of an annulus portion 24b so that the annulus portion 24b locally has a small thickness. As the depressions 24d represent the thin parts that each have a small thickness in the vertical direction, a captured image of the lens component 24 shows bright and dark spots.

FIG. 7 shows a lens component 25 including protruded portions 25d and 25e, which (i) protrude radially outward from a plurality of areas in a side surface of an annulus portion 25b, and (ii) have a smaller thickness than the annulus portion 25b. The protruded portions 25d and the protruded portions 25e are in the vicinity of the top surface and the bottom surface of the annulus portion 25b, respectively. A lens portion 25a has a concave surface and functions as a diffusion lens.

FIG. 8 shows a lens component 26 including protruded portions 26d, which protrude upward from a plurality of areas in the top surface of an annulus portion 26b. Each of the protruded portions 26d has a shape of a cone. As the protruded portions 26d have sloped surfaces, the transmission and reflection of the spotlight in the protruded portions 26d are different from those in other portions of the lens component 26 around the protruded portions 26d. Therefore, a captured image of the protruded portions 26d shows bright and dark spots.

(2) The end surfaces of the thick parts that have a large thickness in the vertical direction, and/or the thin parts that have a small thickness in the vertical direction, may be colored or roughened. This would make the bottom end surfaces of the leg portions 21c colored and roughened in the case of the embodiment. Performing such coloring or roughening processing inhibits a situation where stray light inside the surface mounter 1 is incident on the bottom end surfaces of the leg portions 21c, as well as a situation where part of the spotlight 7c comes out of the bottom end surfaces of the leg portions 21c. As a result, bright and dark spots in the captured image are emphasized.

(3) The bottom end surfaces of the leg portions 21c may be colored by applying colored adhesives thereto between (i) when the mount head 5 starts holding the lens component 21 and (ii) when the image of the lens component 21 is captured. In this case, the component recognition camera 4 may perform image capturing with the colored adhesives applied to the bottom end surfaces of the leg portions 21c, and the lens component 21 may be mounted on the substrate 12 by joining the leg portions 21c, to which the adhesives have been applied, to the top surface of the substrate 12. In the above manner, the process of applying adhesives to the substrate 12 can be omitted. This allows manufacturing LED modules more productively. By way of example, the adhesives may be applied by (i) providing the surface mounter 1 with a container containing a liquid adhesive, and (ii) moving the mount head 5 so as to dip the bottom ends of the leg portions 21c into the liquid adhesive. Note that the adhesives should stay colored only during the image capturing performed by the component recognition camera 4. It does not matter whether the adhesives stay colored or become colorless after they have been dried.

(4) The component recognition camera 4 may be attached to the mount head 5. This way, the component recognition camera 4 can be moved together with the mount head 5 to capture an image of the lens component 21 from above the lens component 21. Here, the mount head 5 may be moved to a position where the light from the LED component 13, which has been mounted on the substrate 12, is irradiated onto the lens component 21. This enables the component recognition camera 4 to perform image capturing while the light from the LED component 13 is being irradiated onto the lens component 21 from below the lens component 21. The LED component 13 can be lit by, for example, supplying power thereto from a power supply pad formed on the substrate 12. By using the LED component 13 mounted on the substrate 12 as a light source for the spotlight as described above, the lighting device 7 can be omitted from the surface mounter 1.

(5) The LED recognition camera 10 may perform image capturing while the LED component 13 mounted on the substrate 12 is being lit. The optical axis 13a of the LED component 13 can be identified from a peak position of a luminance distribution of the captured image. This method allows directly detecting the optical axis 13a of the LED component 13, without the need to capture an image of an external shape of the LED component 13 and identify the optical axis 13a of the LED component 13 from the captured image. Consequently, the accuracy of detecting the optical axis is increased. The LED component 13 is composed of an LED element and a housing. When the housing and the substrate have like colors, it is difficult to identify the external shape (outline) of the LED from the image captured by the LED recognition camera. Even in such a case, the above method can accurately identify the optical axis.

(6) In the embodiment, the lens component 21 includes the annulus portion 21b. However, the lens component 21 may not include the annulus portion 21b.

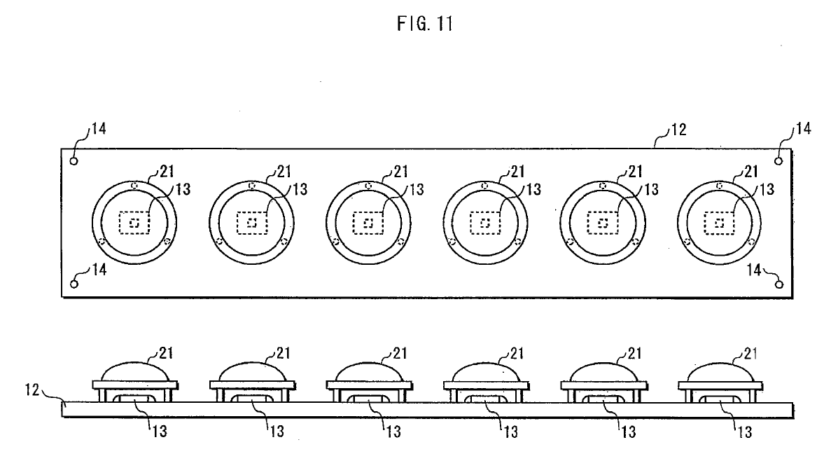

(7) The LED module is not limited to being constructed as shown in FIG. 2. Alternatively, the LED module may be, for example, a single array of LEDs as shown in FIG. 11. The example of FIG. 11 shows that all of the lens components are rotated by the same rotation angle about their respective Z-axes. The present invention, however, is not limited to this structure. Especially, when the substrate is longer in one direction than in another direction, and the lens components are arrayed along the longitudinal direction of the substrate, it is preferable to arrange the lens components after rotating them by differing rotation angles. When the substrate undergoes thermal expansion or negative thermal expansion in the longitudinal direction due to change in the environmental temperature, the substrate is subjected to stress that acts in a certain direction to unglue the lens components. However, rotating the lens components by differing rotation angles prevents a situation where all of the lens components are unglued at the same time.

(8) In the embodiment, the process of recognizing the held state of the lens component and the process of mounting the lens component are performed on each one of the lens components. The present invention, however, is not limited to such a structure. Alternatively, the following exemplary procedures may be taken. First, the held state of one of lens components is recognized. Then, after the position and the rotation angle of the one lens component are adjusted, the one lens component is temporarily placed in a predetermined position on an adhesive tray. Once all of the lens components have been temporarily placed on the adhesive tray, the tray is carried to the vicinity of the substrate. Subsequently, the lens components placed on the tray are mounted onto the substrate in sequence. At this time, the positions and the rotation angles of the lens components placed on the tray have already been adjusted; therefore, the lens components can be mounted in an automatic manner without having to recognize the held states thereof immediately before the mounting operation. When the above procedures are taken, the process of recognizing the held state of one lens component and the process of mounting another lens component can be performed simultaneously. This allows manufacturing LED modules more productively.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A method for mounting a transparent component, comprising the steps of:
causing a mount head to hold the transparent component;
capturing an image of the transparent component with use of a component recognition camera, either from a top side or a bottom side of the transparent component, while the transparent component is being held by the mount head;
recognizing a held state of the transparent component from the captured image;
moving the mount head so as to offset a difference between the recognized held state and a reference state; and
mounting the transparent component in a target position on a substrate by causing the mount head to release the transparent component, wherein
the transparent component locally includes one or both of a plurality of thick parts that each have a large thickness along a direction in which the component recognition camera faces when capturing the image, and a plurality of thin parts that each have a small thickness along the direction, and
the capturing step is performed while a single spotlight or a plurality of spotlights are being irradiated onto the transparent component.

2. The method according to claim 1, wherein
end surfaces of one or both of the thick parts and the thin parts of the transparent component have been colored or roughened.

3. The method according to claim 2, wherein
the transparent component has a plurality of leg portions, which respectively protrude downward from a plurality of areas in a bottom surface of a main body of the transparent component,
each of the thick parts of the transparent component includes a different one of the leg portions,
each of bottom ends of the leg portions has been colored,
the coloring is performed between the causing step and the capturing step by applying a colored adhesive to each of the bottom ends of the leg portions, and
the transparent component is mounted on the substrate by placing the leg portions, each of whose bottom ends has the colored adhesive applied thereto, onto a top surface of the substrate.

4. The method according to claim 1, wherein
a light emitting component that irradiates light in a direction perpendicular to a top surface of the substrate has been mounted in the target position on the substrate,
the mounting step is performed so that the transparent component covers a top side of the light emitting component,
the method further comprises, between the causing step and the capturing step, the step of moving the mount head to a position where the light from the light emitting component is irradiated onto the transparent component, and
in the capturing step, the component recognition camera captures the image from the top side of the transparent component while the light from the light emitting element is being irradiated onto the bottom side of the transparent component as the single spotlight.

5. The method according to claim 1, wherein
a light emitting component that irradiates light in a direction perpendicular to a top surface of the substrate has been mounted in the target position on the substrate,
the mounting step is performed so that the transparent component covers a top side of the light emitting component, and
the moving step includes the substeps of:
capturing an image of the light emitting component with use of a light emitting component recognition camera from a top side of the substrate;
recognizing a position of the light emitting component from the captured image of the light emitting component; and
using the recognized position of the light emitting component as a reference for adjusting the transparent component in position.

6. The method according to claim 5, wherein
the capturing substep is performed while the light emitting component is being lit.

7. The method according to claim 1, wherein
a light source of the single spotlight or each of the plurality of spotlights is a single-color LED.
